(19) United States
(12) Patent Application Publication
(10) Pub. No.: US 2013/0002822 A1
(43) Pub. Date: Jan. 3, 2013

(54) PRODUCT ORDERING SYSTEM, PROGRAM AND METHOD

(75) Inventors: YING-CHUAN YU, Tu-Cheng (TW); YING-XIONG HUANG, Tu-Cheng (TW); SHIH-PIN WU, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 13/278,124

(22) Filed: Oct. 20, 2011

(30) Foreign Application Priority Data
Jun. 28, 2011 (TW) 100122565

(51) Int. Cl. H04N 13/02

(52) U.S. Cl. 348/46; 348/E13.074

(57) ABSTRACT

A product ordering system storing the information of 3D product models including data for forming each of the 3D product models and the scale of each of the 3D product models. A method for ordering a product using the system includes first capturing an image. Then, sensing the distance between the image capturing unit and the user, next, obtaining specific image data from the captured image according to one selected 3D product model, then, converting life size data needed to form a 3D model of the user according to the focus of the image capturing unit and the sensed distance. After that, generating a 3D model of the user according to the scale of the 3D product model, and overlaying the selected 3D product model with the 3D model of the user and displaying the combination for viewing by the user.

### BACKGROUND

1. Technical Field

The present disclosure relates to product ordering systems for ordering products and, particularly, to a product ordering system and program capable of providing an interface for buyers to order products over the Internet and a method for such a product order system.

2. Description of Related Art

Shopping over the Internet has become very popular. However, the disadvantage of shopping over the Internet is that buyers cannot easily determine whether a product such as a piece of clothing or accessory will look good on them because they cannot try it on first before purchasing.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a product ordering system in accordance with an exemplary embodiment.

FIG. 2 is a flowchart of a method for ordering products in accordance with an exemplary embodiment.

### DETAILED DESCRIPTION

Embodiments of the present disclosure will now be described in detail, with reference to the accompanying drawings.

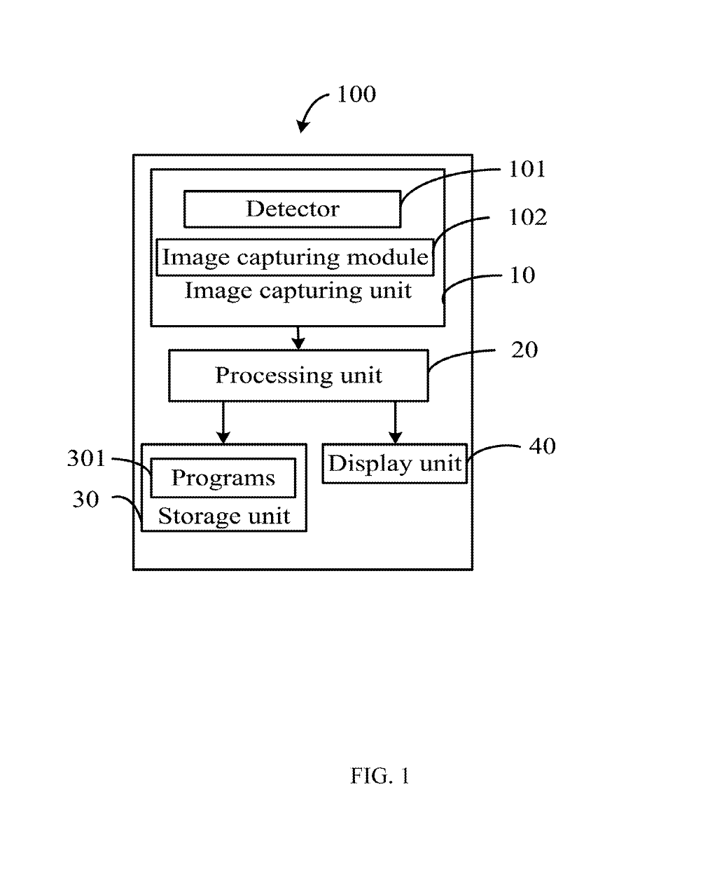

Referring to FIG. 1, a product ordering system 100 includes an image capturing unit 10, a processing unit 20, a storage unit 30, and a display unit 40.

In this embodiment, the storage unit 30 stores the information of three-dimensional (3D) product models and a uniform resource locator (URL) where the product corresponding to the 3D product model can be ordered. The information of each 3D product model includes 3D pictures of products, data forming the 3D product model, the type, size, color, material, price of the products, for example. In the embodiment, the 3D product models can be a variety of commodities, such as wigs, glasses, clothes, for example. In an alternative embodiment, the information of 3D product models and the URL may be stored in a server.

The storage unit 30 further stores programs 301 processed to control the image capturing unit 10 to capture an image of a user. The focus of the image capturing unit 10 is α. In this embodiment, the image capturing unit 10 includes a detector 101 and an image capturing module 102. The detector 101 detects whether a user exists in its detection zone and further detects whether the stay time of the user reaches a preset minimum time length. If the stay time of the user in the detection zone of the detector 101 reaches the preset minimum time length, the detector 101 sense the distance X between the image capturing unit 10 and the user, and the image capturing module 102 captures an image of the user. In the embodiment, the detector 101 may be an infrared detector, and the image capturing module 102 may be a camera. In an alternative embodiment, the image capturing unit 10 captures images of a buyer responding to the operation of the user.

The program 301 is further processed to control the processing unit 20 to control the operation of the system 100, for example, control the system 100 to select one stored 3D product model in response to the input of the buyer. In the alternative embodiment, the processing unit 20 logs in the server stored the 3D product models and select one 3D product model in response to the input of the buyer.

The program 301 is further processed to control the processing unit 20 to obtain specific image data β of the user from the captured image according to the selected 3D product model and stores the specific image data β to the storage unit 30. The image data β may be a particular dimension of the user in the image, such as the height, the distance between eyes, or the distance between shoulders in the image. For example, if the selected 3D product model is a shirt, the processing unit 20 determines the distance between shoulders and the height of the buyer according to the image. If the selected 3D product model is a pair of eyeglasses, the processing unit 20 obtains the distance between the eyes of the user according to the image.

The program 301 is further processed to control the processing unit 20 to convert the image data β to life size data Y of the user according to the focus α of the image capturing unit 10 and the distance X between the image capturing unit 10 and the user. In this embodiment, the processing unit 20 calculates life size data Y of the user according to the formula:

$$\frac{X}{Y} = \frac{α}{β}$$

The processing unit 20 further generates a scaled down 3D model of the user according to the ratio of the life size data Y to a scale of the selected product model. Then the processing unit 20 overlay the 3D model of the user with the selected 3D product model to generate a virtual 3D person model wearing the selected 3D product model.

The program 301 is further processed to control the display unit 40 to display the selected 3D product model and the virtual 3D model of the user wearing the selected 3D product model, and store the virtual 3D model to the storage unit 30 as a history record.

In this embodiment, the program 301 further controls the display unit 20 to display one or more virtual 3D models selected from the storage unit 30 and a virtual 3D model currently formed at the same time to show a comparison. For example, the stored virtual 3D model wearing a 3D shirt model which size is S and the currently formed virtual 3D model wearing a 3D shirt module which size is M may be simultaneously displayed for users to make a comparison.

In this embodiment, the processing unit 20 further rotates the virtual 3D model of the user wearing the selected 3D product model. So that the buyer can judge whether they will look good wearing the product.

In this embodiment, the program 301 further controls the processing unit 20 to obtain the URL associated with the selected 3D product model in response to user input. The user can thus order the product corresponding to the 3D product model over the Internet.

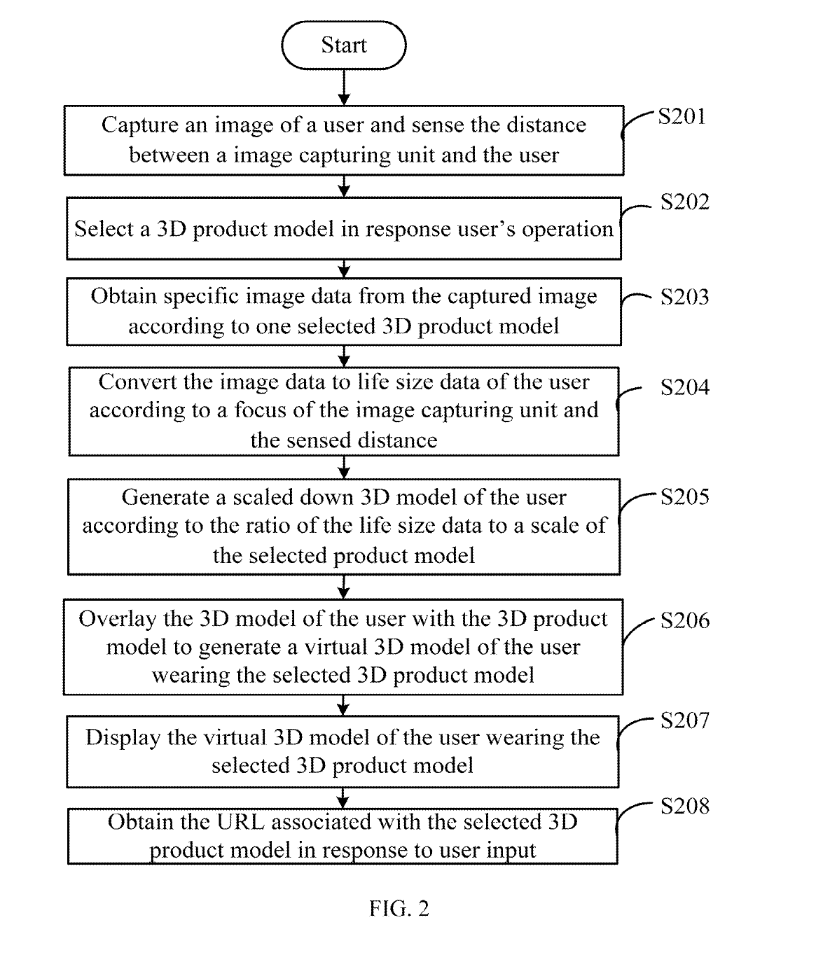

FIG. 2 is a schematic view showing a product ordering method in accordance with an exemplary embodiment.

In step S201, the image capturing unit 10 captures an image of a user and senses the distance between the image capturing unit 10 and the user.

In step S202, the processing unit 20 selects a 3D product model in response to the operations of the user.

In step S203, the processing unit 20 obtains specific image data β from the captured image according to one selected 3D product model.

In step S204, the processing unit 20 converts the image data β to life size data Y of the user according to the focus α of the image capturing unit 10 and the distance X between the image capturing unit 10 and the user.

In step S205, the processing unit 20 generates a scaled down 3D model of the user according to the ratio of the life size data Y to a scale of the selected product model.

In step S206, the processing unit 20 overlays the 3D model of the user with the 3D product model to generate a virtual 3D model of the user wearing the selected 3D product model.

In step S207, the processing unit 20 controls the display unit 40 to display the selected product model and the virtual 3D model of the user wearing the selected 3D product model, and stores the virtual 3D model of the user wearing the selected 3D product model to the storage unit 30 as a history record. In this embodiment, the processing unit 20 further rotates the 3D model of the user wearing the selected 3D product model and displays one or more virtual 3D models selected from the storage unit 30 and a virtual 3D model currently formed at the same time to show a comparison.

In step S208, the processing unit 20 obtains the URL associated with the selected 3D product model in response to user input, the user can thus order the product corresponding to the 3D product model over the Internet.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A product ordering system comprising:
a storage unit storing information of a plurality of three-dimensional (3D) product models comprising data forming each of the 3D product models;
an image capturing unit having a focus and comprising a detector configured to sense the distance between the image capturing unit and a user and an image capturing module configured to capture an image of the user;
a processing unit to select a 3D product model, obtain specific image data from the image of the user captured by the image capturing unit according to the selected 3D product model, convert the image data of the user to a life size data according to the focus and the sensed distance, generate a scaled down 3D model of the user according to the ratio of the life size data to a scale of the selected 3D product model, and overlay the 3D model of the user with the selected 3D product model to generate a virtual 3D model of the user trying on the selected 3D product model.

2. The product ordering system as described in claim 1, wherein the detector is further to detect whether a user exists in its detection zone and further detect whether the stay time of the user reaches a preset minimum time length, if the stay time of the user in the detection zone of the detector reaches the preset minimum time length, the detector sense the distance between the image capturing unit and the user, and the image capturing module captures an image of the user.

3. The product ordering system as described in claim 2, wherein the detector is an infrared detector, and the image capturing module is a camera.

4. The product ordering system as described in claim 1, wherein the detector detects the distance between the image capturing unit and the user and the image capturing unit captures an image of the user in responds to the user's input.

5. The product ordering system as described in claim 1, wherein the information of the 3D product models comprises 3D pictures of products, the type, size, color, material, and price of the products.

6. The product ordering system as described in claim 1, wherein the processing unit is further to log in a server storing the information of 3D product models and select one 3D product model stored in the server.

7. The product ordering system as described in claim 1, wherein the processing unit is further to store the virtual 3D model of the user trying on the selected 3D product model to the storage unit as a history recode, and display the history recode and current virtual 3D model at the same time.

8. The product ordering system as described in claim 1, wherein the processing unit is further to rotate the virtual 3D model of the user trying on the selected 3D product model.

9. The product ordering system as described in claim 1, wherein the information of each of the 3D product model further comprises a URL associated with each of the 3D product models, the processing unit is further to obtain the URL associated with the selected 3D product model in response to user's input.

10. A program applied in a product ordering system, the product ordering system comprising a storage unit storing the information of a plurality of three-dimensional product models comprising data forming each of the 3D product models, an image capturing unit having a focus and comprising a detector and an image capturing module, a processing unit, and the program is processed to:
control the image capturing module to capture an image of a user and control the detector to sense the distance between the image capturing unit and the user;
control the processing unit to select a 3D product model, obtain specific image data from the image of the user captured by the image capturing unit according to the selected 3D product model, convert the image data of the user to a life size data according to the focus and the sensed distance, generate a scaled down 3D model of the user according to the ratio of the life size data to a scale of the selected 3D product model, and overlay the 3D model of the user with the selected 3D product model to generate a virtual 3D model of the user trying on the selected 3D product model.

11. A product ordering method applied in a product ordering system storing information of three-dimensional (3D) product models, the method comprising:
capturing an image of a user and sensing the distance between the image capturing unit and the user;
selecting a 3D product model in response to user's operation;
obtaining specific image data from the captured image according to one selected 3D product model;
converting the image data to life size data of the user according to a focus of the image capturing unit and the sensed distance;
generating a 3D model of the user according to the ratio of the life size data and the scale of the 3D product model; and
overlaying the 3D model of the user with the 3D product model to generate a virtual 3D model of the user wearing the selected 3D product model.

12. The method for ordering product as described in claim 11, further comprising displaying and rotating the virtual 3D model of the user trying on the selected 3D product model.

13. The method for ordering products as described in claim 11, wherein the information of each of the 3D product models comprising a URL associated with each of the 3D product models, the method further comprising:
obtaining the URL associated with the selected 3D product model in response to user input.

14. The method for ordering products as described in claim 11, wherein the method further comprising:
storing the virtual 3D model of the user trying on the selected 3D product model as a history recode and displaying one or more stored virtual 3D models and a virtual 3D model currently formed at the same time to show a comparison.
